(19) United States
(12) Patent Application Publication
(10) Pub. No.: US 2009/0299822 A1
(43) Pub. Date: Dec. 3, 2009

(54) SYSTEM AND METHOD FOR OPTIMIZED SHOPPING TRANSACTIONS

(75) Inventors: Nadav Or HARARI, Kibbutz Yorvata (IL); Yonathan SHALEV, Tel Aviv (IL); Ishai Kadouri, Tel Aviv (IL); Uri WEISS, (US)

Correspondence Address: Dr. D'vorah Graeser, c/o The Discovery Dispatch, 9003 Florin Way, Upper Marlboro, MD, 20772, US

(73) Assignee: P C GROCERY LTD.

(21) Appl. No.: 12/437,553

(22) Filed: May 7, 2009

Related U.S. Application Data
(63) Continuation-in-part of application No. PCT/IL2007/001367, filed on Nov. 8, 2007.
(60) Provisional application No. 60/857,645, filed on Nov. 8, 2006.

(30) Foreign Application Priority Data
Aug. 28, 2007 (GB) 0716552.5

(51) Int. Cl. G06Q 30/00; G06F 17/30; G06Q 50/00; G06Q 10/00

(52) U.S. Cl. 705/10; 705/26; 707/5; 707/E17.017; 707/E17.044

(57) ABSTRACT

A system and a method for constructing a shopping list for purchasing a collection or basket of goods according to a plurality of weighted parameters, preferably with comparison to both “bricks and mortar” stores and also virtual stores (collectively termed suppliers). Preferably the weighted parameters include the ability to prefer friendlier products, such as products which are organic, environmentally friendly, ethical or a combination thereof. Optionally, the user could determine that certain goods could only be purchased from one or more outlets and/or from a particular type of outlet. Optionally and preferably, the optimization includes determining whether to purchase a larger amount of a product in order to enjoy price savings for that product. According to other preferred embodiments, the user may optionally choose to divide a basket of products between a plurality of suppliers, rather than optimizing the basket at a single supplier.

This application claims priority from PCT Application No. PCT/IL2007/001367, filed on Nov. 8, 2007, currently pending, which claims priority from United Kingdom Application No. 0716552.5, filed on Aug. 28, 2007, also currently pending, and from U.S. Provisional Application No. 60/857,645, filed on Nov. 8, 2006, expired, all of which are hereby incorporated by reference as if fully set forth herein.

### FIELD OF THE INVENTION

The present invention relates to a system and a method for optimized shopping transactions, and in particular, to such a system and method for weighting a plurality of parameters for such shopping transactions according to one or more preferences of the user for purchase of a collection of goods through an electronic network.

### BACKGROUND OF THE INVENTION

The Internet has enabled computer users all over the world to interact and communicate electronically. One particularly popular mode for communication is through Web pages, which collectively form the World Wide Web. Web pages are useful for displaying text and graphics, and even animation, video data and audio data. Unsurprisingly, Web pages have also become popular for electronic commerce (e-commerce), as they enable vendors to display various types of goods to users, and to effectively advertise these goods. A large number of Web sites are currently devoted to e-commerce, and users can purchase a wide range of goods, from books to electronic equipment and even perishable goods, such as groceries.

Various systems and methods have been proposed for permitting the user to compare the price of a single product with multiple vendors through the Internet. This comparison is useful for expensive or “big ticket” items, which users are more likely to purchase singly, such as computers and other electronic goods, home appliances and automobiles. However, this comparison is less useful for goods which are of value to the user when purchased as part of a collection. For example, when shopping for groceries, a store which sells a jar of coffee for the lowest price may nonetheless cause the user to spend more for a collection or “basket” of goods. For any type of shopping in which the user wishes to purchase a basket of goods, of which groceries are a typical example, comparison shopping for a single product is not useful.

Other systems and methods have been proposed which purport to allow the user to consider the entire price of a basket of goods when selected according to a shopping list by the user, and to compare this entire price at more than one store. For example, US Published Application No. 2006/0113383 describes a method for optimizing a grocery list according to the dietary requirements of a user, if the user has an allergy or wishes to avoid high fat foods, and/or according to price of the shopping list. The price may also optionally relate to coupons or sale (reduced) prices at a store.

US Published Application No. 2005/0160006 describes a method for comparative shopping for a basket of goods at local “bricks and mortar” grocery stores. The method permits the user to shop at more than one store, but only contemplates price and does not attempt to suggest changes to the shopping list in order to optimize the basket of goods.

US Published Application No. 2005/0097003 also describes a method for comparative shopping for a basket of goods at local “bricks and mortar” grocery stores. The user can view the floor-plan at the local grocery store, as the user is expected to travel to the store in order to purchase the goods. The method does not distinguish between a single product or a basket of products, as the price is compared and displayed for each product individually, such that the basket itself is not optimized.

US Published Application No. 2005/0075945 also describes a method for comparative shopping for a basket of goods at local “bricks and mortar” grocery stores and is in fact highly similar to the above application. Again, the basket of goods is not optimized.

US Published Application No. 2006/0190348 to Ofer et al., also describes a method for comparative shopping for a basket of goods and optimization but only for splitting the order between a plurality of suppliers. Optimization of the shopping as defined by user control parameters is not taught or suggested.

Furthermore, the above references do not replicate all of the different types of selection which may be made by the user at an actual grocery store. For example, the user could choose to purchase a greater amount of a certain item if cheaper in bulk, or could choose to forgo certain expensive items in one area in order to purchase other expensive items, for example by choosing organic vegetables over steak (or vice versa). Users typically perform many such calculations while shopping for a variety of reasons. The above references do not permit such a balance of calculations.

The above references also refer strictly to purchases of goods through on-line stores, which relate to the on-line presence of “bricks and mortar” grocery stores. However, users may prefer to also purchase goods directly from farmers and/or other suppliers of produce, eggs, dairy foods, meat and/or fish, particularly for organic foods, or in the case of eggs, dairy foods and meat, free range and/or hormone and antibiotic free products. This possibility is not considered by the above references, which limit users to an optimized shopping list at “bricks and mortar” stores, rather than permitting a combination of “bricks and mortar” and virtual (no physical point of sale) stores. Thus, the above references do not fully support a complete range of choice for shopping for a basket of goods for the user.

### SUMMARY OF THE INVENTION

There is an unmet need for, and it would be highly useful to have, a system and a method for optimized shopping transactions for purchasing a collection or basket of goods.

There is also an unmet need for, and it would be highly useful to have, a system and a method for optimizing such a shopping transaction for purchase from both “bricks and mortar” stores and also virtual stores (with no physical point of sale), herein collectively termed suppliers.

The present invention overcomes these drawbacks of the background art by providing a system and method for optimizing shopping transactions for purchasing a collection or basket of goods, preferably with comparison to both “bricks and mortar” stores and also virtual stores. Optionally, the user could determine that certain goods could only be purchased from one or more outlets and/or from a particular type of outlet. Optionally and preferably, the optimization includes determining whether to purchase a larger amount of a product in order to enjoy price savings for that product. The optimization also optionally and preferably comprises selecting the shopping items for purchase according to a plurality of weighted parameters, in which the parameters are weighted according to one or more preferences of the user.

According to preferred embodiments of the present invention, the weighted parameters are determined according to one or more priorities (relative preferences of the user) according to which the shopping list is to be optimized. For example, the user may require all fruits and vegetables to be organic, but may be flexible as to which fruits and vegetables are purchased, and/or the amounts to be purchased. The user may also indicate the option to purchase or not purchase certain “optional” items (as defined by the user) according to whether the budget permits such purchases. For example, the user could decide to purchase frozen prepared meals only if there are sufficient funds in the budget and/or could decide to vary the number of such meals purchased according to the budget.

According to still other preferred embodiments of the present invention, there is provided a system and method for observing a plurality of purchases by the user, determining at least one pattern of shopping by the user and providing a suggested shopping list according to the at least one pattern of shopping by the user. For example, the system and method may optionally monitor the user's purchases over a period of time, and then recommend one or more changes to the pattern of such purchases in order to reduce costs. For example, if the user habitually purchases a certain amount of non-perishable goods per month, such as toilet paper, aluminum foil, soap or any other such non-perishable goods, the optimization of the shopping list could optionally and preferably include a recommendation to purchase one or more of such goods in a larger amount but less frequently. For example, the user may optionally receive the recommendation to purchase a large bottle of soap once per month rather than smaller bottles more frequently, in order to save money with the single larger purchase.

According to other preferred embodiments, the user may optionally choose to divide a basket of products between a plurality of suppliers, rather than optimizing the basket at a single supplier.

According to a still further preferred embodiment, a search for a product is optionally available to the user wherein the user enters a search string with respect to the product that the user is searching for and/or otherwise performs a more general search for a product, for example according to a category for the product. This search is preferably performed according to a request of the user through a user interface, which is more preferably an electronic interface (for example through a computer as described in greater detail below). This implementation is similar to that of searching up and down the aisles and shelves of a store for a particular item. Optionally the search may be implemented by searching within a particular product category, for example searching within the bread category, optionally for a particular type of bread such as for yeast free breads or gluten free breads. Optionally the search may be carried for a particular supplier, producer or brand name, for example a paint brand may be searched allowing the user to view the various available products from that brand.

The search results are preferably displayed through any type of suitable display, including but not limited to a monitor or other display screen of a television; printing on a printer; sending through e-mail, facsimile, SMS or any other type of message transmission; display on a cellular telephone screen and/or smart phone or PDA (personal data assistant) screen; and so forth. The display preferably also includes one or more of the following: an indication of the name of the product, any amount to be added to the shopping trolley, a per unit price, a total number of units, a total price and also optionally an indication of a special price, for example for purchasing a particular quantity or quantities. The display may also optionally relate to the content of the shopping trolley and a “running total” of the total products in the trolley, more preferably listed according to each of a plurality of totals for a plurality of different providers, such as virtual stores and/or physical stores.

The displayed search results preferably and optionally allow the user to select a product from the search results thereby causing it to be added to the shopping list. The product may also optionally be added automatically to the shopping list. Preferably the search results presented to the user may include alternative and equivalent products for the user to choose from. For example, if a user searches for a dairy product, such as yoghurt, the search results are preferably presented such that not only is the user able to choose from different yoghurt suppliers but the type of yoghurt is also preferably displayed, thereby allowing the user to choose a yoghurt by percentage fat, flavor and the like.

According to preferred embodiments of the present invention, at least one user preference may optionally and preferably be related to friendlier products. More preferably, the friendlier product includes one or more of an organic product, an environmentally friendly product and an ethical product. The determination of whether a product is organic preferably includes any organically grown or manufactured product, and is most preferably made according to certification by an organization and/or the government. An ethical product preferably includes any product produced with ethical materials and/or according to an ethical standard, including but not limited to one or more of a product that does not involve cruelty to animals, a product that was not tested on animals or was not unnecessarily tested on animals, a product that is sustainably grown, produced or manufactured, a product that is produced according to Fair Trade requirements, or that is otherwise certified to be ethical by an organization providing such certification.

Generally, a certified product is one that has received certification from a government, an organization, an NGO (non governmental organization), a QANGO (quasi non governmental organization) or a QUANGO (quasi autonomous non governmental organization) according to one or more standards.

Growing environmental awareness inspired by mass media coverage of environmental issues such as the greenhouse effect, global warming, “mad cow” disease, unpredictable and changing weather patterns has impelled most industries to introduce more environmentally friendly products such as CFC free aerosols, hybrid cars, free range egg and poultry products, livestock not treated with antibiotics or hormones, pesticide free produce and the like. Similarly, growing awareness with respect to human health issues in its relation to the products consumed and/or has driven industry to offer healthier, environmentally friendly products such as organic produce, low carb (carbohydrate) products, heart smart foods, whole grain foods and the like.

The terms and symbols associated with such environmentally friendly and/or health food products vary between industries and companies; for example and without limitation the terms may include: friendlier, greener, organic, health smart, heart smart, ozone friendly, environmentally friendly, animal friendly and so forth. For the sake of simplicity, clarity and unity, the term “friendly” is used throughout this application to collectively refer to the group of environmentally conscious, organic, and/or health products as described above.

According to a still further preferred embodiment the user may optionally choose to create a friendlier shopping basket wherein an alternative shopping list is presented to the user optionally and preferably listing at least one product as an alternative choice that belongs to the friendlier product type, for example including but not limited to one or more of organic foods, healthier foods, organically grown livestock and produce, environmentally friendly and/or healthier products. Optionally this would present the user with the option of purchasing products that may be a healthier or environmentally friendly despite the potential increase in overall price. Preferably and optionally the price difference between the friendlier list and the chosen list is presented to the user prior to looking at or at least selecting the individual friendlier products.

Although the embodiments depicted above are exemplarily depicted with regard to the grocery shopping process, however, the present system and method is not limited to the grocery shopping process. The system and method of the present invention may be similarly applied to and implemented in any type of shopping processes where the individual products may be optionally and preferably purchased in a package deal.

For example, the system and method of the present invention may alternatively compare and optimize holiday packages providing the user with alternatives to maximize the user's available budget in purchasing flight, hotel, car rental, food packages or any alternative thereof. For example, if the budget does not allow for car rental then an optional optimized alternative would be to substitute it with public transportation services. The choice of public transportation as an option may also be presented to the user as the “friendlier” or greener alternative as it is a more environmentally friendly option. Carbon offsets and their prices may also optionally be considered when purchasing a holiday package, whether from the provider of the package and/or of a component thereof, or alternatively (or additionally) purchased separately.

Similarly, the present invention may be implemented in shopping for a mobile telephone package where the user may choose from various mobile telephone packages based on usage criteria, SMS availability, GPRS availability and the individual rates that go along with it. The alternative “friendlier” package may optionally include a cellular telephone having reduced radiation, for example.

Additionally for example, the present invention may be applied to a computer hardware and software package for purchasing and optimizing. A package for example including but not limited to a computer, monitor, keyboard, DVD and camera, are packaged and optimized as a package amongst various suppliers. Similarly, the friendlier or greener version may optionally be one that uses recycled parts or recyclable components.

Additionally for example, the system and method of the present invention may be applied to the purchase of insurance, where a package of insurance policies for example including but not limited to car insurance, health insurance, home owner's insurance and travel insurance may be compared and optimized amongst various vendors or suppliers.

According to preferred embodiments, the present invention may optionally relate to the purchase of any commercial product. More preferably, there is provided a method for interactively selecting at least commercial item for a user, comprising: determining a plurality of weighted parameters for preferences of the user, each parameter being weighted according to a relative preference of the user; and automatically selecting the at least one commercial item from a plurality of providers according to the weighted parameters. Most preferably, the method further comprises selecting a plurality of related commercial items from a plurality of providers according to the weighted parameters.

Any one of the above mentioned applications may also apply a greener or environmentally friendlier option, whereas food may be organic, a car may be more environmentally friendly, the product could be made from recycled materials, the product is itself recyclable, the company producing it having global or local environmental standard certificate or an ISO certificate.

The system and method of the present invention may be equally useful for the suppliers that supply the products. Information regarding user's product preferences and trends will be available to the supplier preferably providing them with an analysis of the shopper and how they shop at their store, which products are more profitable, the information obtained by the system and method of the present invention may therefore optionally utilized to improve sales for the supplier. Preferably any such analysis will be made available by the system and method of the present invention depending on the type and needs of the supplier.

The friendlier products may be offered by various suppliers and may be found in the large supply food chains. However, increasingly consumers may prefer to purchase friendly goods at specialty stores that optionally specialize in providing organic or otherwise friendlier products. Optionally an embodiment of the present invention enables the products of the specialty friendly shops to be purchased by the user, even if such shops are not supermarkets. Furthermore the friendlier products may be optionally made available to the user as an alternative to traditional products that are not necessarily friendly (or not as friendly). Optionally the user may also be provided with the opportunity to make the entire shopping list “friendlier”, preferably with a description of any additional cost involved, more preferably on a separate basis for each provider or supplier. For example, the user may optionally be provided with a button to select on-line in order to cause the shopping list to be reconstructed with at least one friendlier or friendly product.

A further optional tool made available to the suppliers by the system and method of the present invention is the option of advertising for making their products readily visible to the audience of consumers. Optionally a supplier may advertise its products by having them appear at the top of the available list or as an alternative product, for example according to a preferred listing location. Optionally, the system and method would be able to control the order in which the products are presented to obtain a more favorable location on the display, for example on the Web site displaying the products. Therefore the system and method of the present application optionally and preferably may not provide advertisements in a conventional manner, but rather they reach the user (consumer) by making the product easier to view through increasing the ranking of the product to place it at the top of the list.

Optionally there is an advertising area where there are a plurality of active links that allow the user to learn about the suppliers and the various products that they offer.

According to preferred embodiments of the present invention, there is provided a for interactively constructing a shopping list for a user, comprising: determining a plurality of weighted parameters for preferences of the user, each parameter being weighted according to a relative preference of the user; automatically selecting shopping items from a plurality of providers according to the weighted parameters; and constructing the shopping list according to selected shopping items for the user.

Optionally, at least one preference is a negative preference, such that the at least one parameter has a negative weight. Also optionally, at least one preference is an absolute preference which must be fulfilled.

Optionally and preferably, the weighted parameters further comprise parameters relating to at least one of cost, friendlier products, brand name products, an identity of a supplier of a product, a certified product and products corresponding to at least one dietary restriction.

More preferably, the friendlier products include at least one of an organic product, an environmentally friendly product and an ethical product.

Optionally cost includes cost of a product. Optionally (additionally or alternatively), cost includes cost of all of the shopping items. Preferably, cost includes cost of delivery of one or more of the shopping items, or all of the shopping items.

Optionally, at least one provider is a “bricks and mortar” store. Preferably, at least one provider is a virtual store. More preferably, the virtual store comprises a farmers' cooperative.

According to some embodiments, the method further comprises: observing a plurality of purchases by the user; determining at least one pattern of shopping by the user; and providing a suggested shopping list according to the at least one pattern of shopping by the user.

According to other embodiments, the method further comprises: searching for at least one product according to a request by the user according to a search string and/or a category through a user interface; and adding a product located through the searching to the shopping list for the user.

According to other embodiments of the present invention, there is provided a system for interactively constructing a shopping list for a user, comprising: a user computer for entering at least one preference of the user; a server for receiving the at least one preference and for: determining a plurality of weighted parameters for preferences of the user, each parameter being weighted according to a relative preference of the user; automatically selecting shopping items from a plurality of providers according to the weighted parameters; and constructing the shopping list according to selected shopping items for the user; and a network for connecting the user computer and the server.

According to still other embodiments of the present invention, there is provided a method for interactively selecting at least one commercial item for a user, comprising: determining a plurality of weighted parameters for preferences of the user, each parameter being weighted according to a relative preference of the user; and automatically selecting the at least one commercial item from a plurality of providers according to the weighted parameters.

Preferably the method further comprises selecting a plurality of related commercial items from a plurality of providers according to the weighted parameters.

According to yet other embodiments of the present invention, there is provided a method for interactively constructing a shopping list for a user, comprising: selecting shopping items from a plurality of providers according to a request of the user; constructing the shopping list according to selected shopping items for the user; examining the shopping list to locate at least one friendlier product from at least one provider; and reconstructing the shopping list to include the at least one friendlier product.

Preferably, the plurality of providers includes at least one virtual store and at least one physical store.

Optionally and preferably, the selecting the shopping items further comprises: searching through a plurality of products according to a request by the user; and displaying a result of the searching to the user.

More preferably, the displaying the result further comprises: displaying a running total of a cost of a plurality of products requested by the user.

Most preferably, the displaying the running total further comprises displaying a total cost of the products from a plurality of providers.

According to some embodiments of the present invention, there is provided a method for combining information from a plurality of stores into a unified “store”. The unified “store” may optionally be presented as described above, for example through the above described illustrative GUI; alternatively or additionally, the combined data may optionally be used for any other type of interaction with the end user (consumer), for example to automatically construct the shopping list for the user according to one or more user preferences, as described herein.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager, TV decoder, game console, digital music player and/or ATM (machine for dispensing cash). Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary, illustrative non-limiting embodiment of a system according to the present invention; and

FIG. 2 is a flowchart of an illustrative, exemplary non-limiting method according to the present invention.

FIG. 3 is a flowchart of an illustrative, exemplary non-limiting method according to the present invention.

FIG. 4 is an illustrative, exemplary non-limiting graphical user interface (GUI) of the present system and method according to the present invention depicting the primary interface.

FIG. 5 is an illustrative, exemplary non-limiting graphical user interface (GUI) of the present system and method according to the present invention showing the search and results interface.

FIG. 6 is an illustrative, exemplary non-limiting graphical user interface (GUI) of the present system and method according to the present invention showing the comparative results along with optimization alternative interface.

FIG. 7 is an illustrative, exemplary non-limiting graphical user interface (GUI) of the present system and method according to the present invention showing the optimization interface.

FIG. 8 is an illustrative, exemplary non-limiting graphical user interface (GUI) of the present system and method according to the present invention showing the checkout interface.

FIG. 9 is an illustrative, exemplary non-limiting graphical user interface (GUI) of the present system and method according to the present invention showing the search interface.

FIG. 10 is an illustrative, exemplary non-limiting method for combining information from a plurality of stores into a unified “store”.

### DESCRIPTION OF THE PREFERRED EMBODIMENTS

The present invention is of a system and a method for optimizing shopping transactions for purchasing a collection or basket of goods “on-line” through an electronic communication medium. The collection of goods is preferably selected according to a plurality of weighted parameters which are weighted according to relative user preferences.

For example the user may optionally define a particular product as an absolute need by indicating that this parameter is to be an absolute parameter (ie a parameter to be given 100% weighting). For example a user that has a food allergy or specific dietary requirements such as lactose intolerance, may optionally and preferably indicate that the purchased products must be lactose free. Similarly, a user may define that he or she wishes to get free range eggs and poultry products as an optional but preferred choice, but not as an absolute requirement for the user. In this case, a weight for the parameter is preferably set indicating that if free range eggs are available then to purchase them, however if not available an alternative non free range egg is considered an alternative. Similarly, a particular brand of coffee, type of coffee or diaper, or of any other product, may optionally be given a weight in relation to a user preference.

User preferences may also optionally and preferably be used to indicate a negative preference, such that the associated parameter has a negative weight.

The weighted parameters preferably comprise parameters relating to at least one of cost, friendlier products, brand name products, an identity of a supplier of a product, a certified product and products corresponding to at least one dietary restriction.

The parameter weighting range may optionally be defined or graded in a scale such as a scale of 1 to 10 and/or in a percentage scale. Therefore each product parameter may optionally be associated with a grading which will be used to determine the user's relative flexibility with respect to the product. For example, an absolute need for lactose free products as described above may be graded 1 or as 100% and therefore defined as an absolute need. Similarly, for example a the coffee brand choice described above may be given a scale grade of 3 or as 70% allowing some room for changing the product but not too much. The relative parameter example of free range chicken eggs or described above may be graded 7 or 30% to show the relevant importance the user associates with that particular product but it may not be sufficiently important to mark it as a absolute need.

Preferably both bricks and mortar stores and virtual stores are included as potential sources for goods to be included in the optimized shopping list, or suppliers as described in greater detail below. The term “virtual store” preferably encompasses any supplier without a physical store, enabling users to purchase goods directly from farmers and/or other suppliers of produce, eggs, dairy foods, meat and/or fish, particularly for organic foods, or in the case of eggs, dairy foods and meat, free range and/or hormone and antibiotic free products. Such farmers and/or other suppliers of produce may optionally be organized into one or more cooperatives, as is known in a number of countries worldwide, including but not limited to the US and the United Kingdom. Such cooperatives may also optionally be preferred by users because of the desire to purchase goods produced locally (ie within a relatively close physical distance to the home of the user).

According to some embodiments of the present invention, there is provided a system and method for purchasing a product from a virtual store. The virtual store preferably includes one or more suppliers of fresh products, more preferably including one or more suppliers of fresh produce, eggs, dairy foods, meat and/or fish. According to an embodiment of the present invention, the virtual store is a greengrocer, and sells fresh produce, preferably from a friendlier supplier as described herein, which may optionally and preferably be an organic and/or local supplier.

Bricks and mortar stores may optionally comprise any type of supermarket and/or specialty store (for example for selling “health” food and/or vegetables and fruit and/or meat and/or fish, for example). The combination of all of these different types of stores enables the present invention to provide a “hyper supermarket”, in which the user may optionally select from any type of supplier without being limited to a single physical store but also without being forced to travel to multiple locations in order to conduct shopping.

Optionally and preferably, the optimization includes determining whether to purchase a larger amount of a product in order to enjoy price savings for that product. The unit price per unit volume or weight of the product frequently is reduced when a larger amount of the product is purchased.

According to preferred embodiments of the present invention, the user provides a budget and one or more priorities according to which the shopping list is to be optimized. The user may optionally require certain items to be purchased and may also optionally require at least minimum amounts of these items to be purchased, but may optionally and preferably otherwise provide flexibility in terms of optimization of the remainder of the shopping list. For example, the user may require all fruits and vegetables to be organic, but may be flexible as to which fruits and vegetables are purchased, and/or the amounts to be purchased. The user may also indicate the option to purchase or not purchase certain “optional” items (as defined by the user) according to whether the budget permits such purchases. For example, the user could decide to purchase frozen prepared meals only if there are sufficient funds in the budget and/or could decide to vary the number of such meals purchased according to the budget.

According to still other preferred embodiments of the present invention, there is provided a system and method for monitoring the user's purchases over a period of time, and then recommending a shopping list based on a pattern determined from such monitoring. Optionally the recommended shopping list may also include one or more changes to the pattern of such purchases in order to reduce costs. For example, if the user habitually purchases a certain amount of non-perishable goods per month, such as toilet paper, aluminum foil, soap or any other such non-perishable goods, the optimization of the shopping list could optionally and preferably include a recommendation to purchase one or more of such goods in a larger amount but less frequently. For example, the user may optionally receive the recommendation to purchase a large bottle of soap once per month rather than smaller bottles more frequently, in order to save money with the single larger purchase.

According to still other preferred embodiments of the present invention, there is provided a system and method for optionally and preferably certifying the source of products and/or the products themselves according to one or more certifications. Such certifications may optionally include but are not limited to a religious certification (such as for kosher or hallal foods for example), an organic certification and/or a free-range certification and/or a non-hormone or non-antibiotic treated certification (the latter typically applies to poultry or livestock products). Such certifications may optionally and preferably be used as one or more of the parameters according to which the shopping list is optimized. Preferably, the user is able to view a copy of an actual certificate on-line.

According to still other preferred embodiments of the present invention, the user is preferably able to review the shopping list created according to the present invention, and is then able to adjust one or more aspects of the shopping list. Such an adjustment may optionally comprise a specific adjustment, such as adding, removing and/or otherwise changing at least one product on the list, optionally including changing an amount of such a product. Such an adjustment may optionally comprise a global adjustment, wherein at least one overall parameter may optionally be applied to a plurality of products on the list, preferably according to category of product and/or a type of product, for example according to at least one certification as previously described.

The principles and operation of the present invention may be better understood with reference to the drawings and the accompanying description.

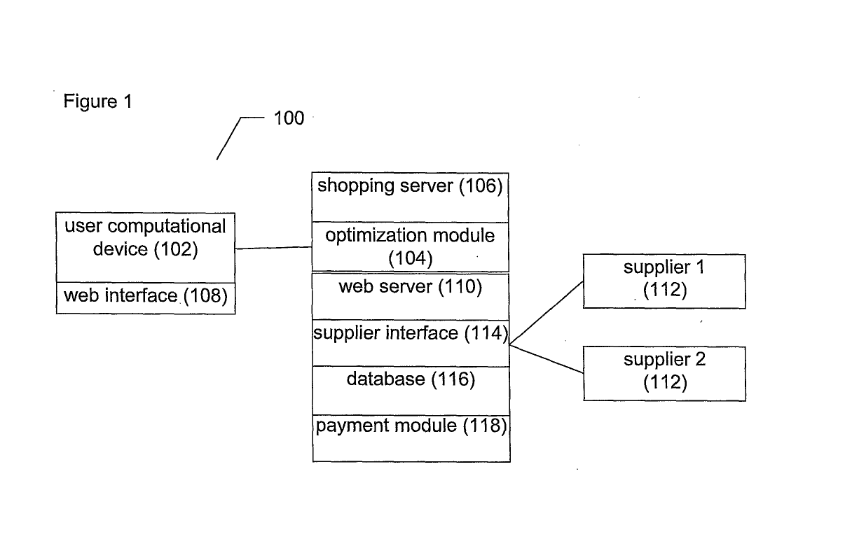

Referring now to the drawings, FIG. 1 is a schematic block diagram of an exemplary, illustrative non-limiting embodiment of a system according to the present invention.

System 100 according to the present invention supports on-line communication between a user computational device 102 and an optimization module 104 at a shopping server 106. By “online”, it is meant that communication is performed through an electronic communication medium, including but not limited to, telephone voice communication through the PSTN (public switched telephone network), cellular telephones or a combination thereof; exchanging information through Web pages according to HTTP (HyperText Transfer Protocol) or any other protocol for communication with and through mark-up language documents; exchanging messages through e-mail (electronic mail), messaging services such as ICQ™ for example, and any other type of messaging service; any type of communication using a computational device as previously defined; as well as any other type of communication which incorporates an electronic medium for transmission.

According to preferred embodiments of the present invention, communication is performed according to a mark-up language protocol as shown with the illustrative, exemplary embodiment of a web interface 108 for user computational device 102 and a web server 110 at shopping server 106.

For suppliers 112, shown as supplier 1 and supplier 2, preferably shopping server 106 supports a supplier interface 114, which is also preferably a web interface. Suppliers 112 may optionally interact with supplier interface 114 through a web page and/or through installed software (not shown).

Turning first to suppliers 112, each supplier 112 preferably provides information about one or more products that are available and their prices, for entry to a database 116. The information preferably includes a description of the product, such as the type of product, weight or volume (amount) being sold, brand (if any), price and so forth. The information may optionally include one or more certifications as previously described; for such certifications, preferably a scanned image of the actual certificate is made available, and/or some other type of proof of certification. The information also optionally and preferably includes a description of a delivery service available and cost.

Alternatively, such information may optionally be entered independently of any action by a supplier 112, for example through manual and/or automatic data entry from other sources. It should be noted that the present invention may optionally be operated for comparative price shopping only, without the cooperation of a supplier 112. For the preferred embodiment shown, suppliers 112 interact with shopping server 106.

For example and without any intention of being limiting, supplier 1 112 may optionally be a supermarket, whether bricks and mortar or virtual (ie without a physical point of sale), while supplier 2 112 may optionally be a supplier of a particular category or type of product and/or a cooperative of such suppliers. For example, supplier 2 112 may optionally be a cooperative of organic produce farmers and/or one or more individual farmers, or any other supplier. Non-limiting, illustrative examples of such cooperatives include Scottish Organic Producers Association Limited (Edinburgh, Scotland, United Kingdom), which serves as an umbrella organization for a plurality of growers; Clyde Organics, Muirhouse Farm, Carnwath, Lanarkshire, ML11 8RX, which provides organic food (including fruit, vegetables and dairy products) for purchase by individuals); Honeysuckle Whole Foods Co-operative Limited, Shropshire, United Kingdom, which is a retailer that collects organic foods from many producers; and so forth. Of course any other type of cooperative could optionally also participate, for example with assistance for collection and delivery of products.

The user (not shown) preferably enters and/or selects one or more products for purchase through web interface 108, which could for example optionally be implemented through any type of web page, optionally with one or more plug-ins for example. If the exact product is not clear and/or is not available, then the user may be shown one or more choices and prompted to make a selection as described in greater detail below. The user may also optionally enter a request for one or more certifications as previously described. The user is then preferably prompted to indicate one or more preferences with a relative weight; the preferences may be negative in which case the weight is negative; the preferences may also optionally be absolute, in which case they must be used by optimization module 104 during optimization of the shopping list, as otherwise they are optionally be used by optimization module 104 during optimization of the shopping list. The user also preferably enters a weight for each parameter, to indicate the relative importance of the parameter.

Parameters from user preferences may optionally and preferably include but are not limited to one or more of the following: price; weight and/amount and/or unit number of each product in the basket; unit size of the product, which may optionally be related to the number of units in a package and/or the total number of units purchased; brand, optionally including private label, non-brand and/or one or more specific brand name products; score of the product given by the user placing the order and/or one or more other users (as for user reviews for example); score of the supplier as given by the user placing the order and/or one or more other users (as for user reviews for example); whether a product is organic; whether it is produced or obtained according to fair trade principles (see for example the International Fair Trade Standards as determined by the international certification body Fairtrade Labelling Organisations International (FLO) and/or other Fair Trade bodies; basically refers to standards for producers and traders which allows small farms and workers to obtain fair wages and/or prices for their goods); products produced without hormones and/or antibiotics (for example for poultry and poultry products, meat and dairy products); special offers relating to the amount purchased—buy two get one free, buy more pay less, and so forth.

It should be noted that one of the many advantages of the present invention is that the unit size sold and/or the number of units sold at a particular price no longer needs to be determined by fixed packaging, as the on-line calculator is able to determine a price in a flexible manner. For example, instead of a “six pack” of six cans of soda, a “five pack”, an “eight pack” or any other “pack” size could optionally be profitably sold.

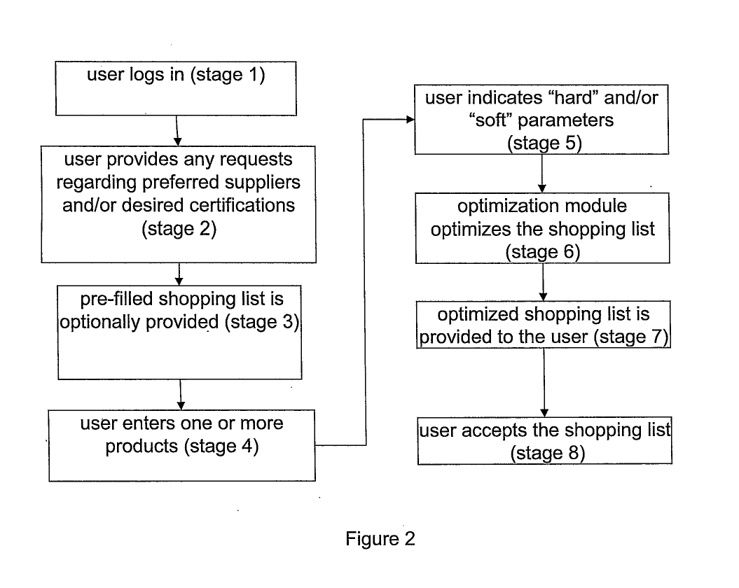

Optimization module 104 then considers the parameters for optimizing the shopping list. Optionally, optimization module 104 also considers a total budget, which is the amount that is either an absolute maximum or a preferred maximum that the shopping basket must cost. Optimization module 104 also preferably includes such factors as delivery time and price in the optimization of the shopping list. A non-limiting example of a preferred method for optimization is given in FIG. 2 below, although optionally any type of suitable optimization method may be implemented.

Once the shopping list has been optimized, optimization module 104 optionally and preferably sends it to the user for approval, preferably through web interface 108 although optionally through any other type of communication method (including but not limited to e-mail, text messaging, facsimiles and the like). The user may then optionally make changes, either to specific aspects of the shopping list and/or to one or more overall, global parameters, after which optimization module 104 preferably optimizes the shopping list again. More preferably, the user communicates through web interface 108 and the new optimized shopping list is displayed through web interface 108.

If the user approves, then preferably payment module 118 communicates with the user, more preferably through web interface 108. The user provides some type of payment, optionally selected from the group including but not limited to credit card, debit card, electronic check, bank transfer and the like. If permitted, for example by suppliers 112, the user may be billed after the products have been received and/or may have a monthly account (or other type of periodic account), which is paid after a set period of time has elapsed.

Once payment module 118 has approved of the payment by the user, payment module 118 preferably notifies the necessary suppliers 112, preferably through supplier interface 114 although optionally any type of communication may be used. Payment module 118 also preferably determines when delivery is expected according to supplier(s) 112; this information is then communicated to the user. For example, the user may optionally be invited to select from a plurality of delivery days and/or times; optionally an additional fee may be charged for a more rapid delivery and/or for delivery at certain day(s) and/or times. Payment module 118 may optionally receive delivery information in advance from supplier(s) 112, to be optionally and preferably stored (for example) in database 116. Payment module 118 may optionally also hold delivery of any part of a shopping basket if one part is not ready on time, or may alternatively schedule delivery from each supplier 112 separately, optionally for a separate fee. Delivery is then made to the user of the product(s) ordered.

FIG. 2 is a flowchart of an illustrative, exemplary non-limiting optimization method according to the present invention for operation with the system of FIG. 1. In stage 1, the user preferably logs into the system or is otherwise identified by the system, more preferably through the shopping server. Optionally, the user is identified through the use of a “cookie” or other stored data and/or software, and/or through the use of a hardware peripheral device such as a dongle for example. Preferably, details regarding the user are saved on the shopping server so that the user is identified upon login; optionally previously ordered baskets and/or items are displayed, and/or preferred items and/or preferences are displayed.

If the user is new or is not known to the system, preferably the user is requested to enter location information (such as zip code and/or other geographical and/or address information), after which the user is preferably guided through the log-in process. The user may optionally and preferably enter credit card and/or other payment information, optionally for storage on the system.

In stage 2, the user is optionally requested to provide any requests regarding preferred suppliers and/or desired certifications. If the user's preferences are known, then such preferences may optionally be implemented without further input by the user. For example, optionally and preferably one or more hard and/or soft parameters previously entered by the user are stored for use during the optimization process.

In stage 3, the user is optionally provided with a pre-filled shopping list, preferably pre-filled according to one or more preferences of the user and/or according to previous shopping list(s) of the user. If the user's preferences and/or shopping habits are not known, then optionally this stage is skipped.

In stage 4, the user optionally enters one or more products to the shopping list and/or makes one or more changes and/or additions and/or deletions. The user optionally and preferably is provided with a list of products, more preferably by category, from which one or more choices may be made. The list is preferably adjusted according to the previous request(s) for certification and/or preferred suppliers, such that the user preferably only views those products which meet these request(s).

In stage 5, the user indicates weights for the parameters. If the user previously indicated such preferences, as described with regard to stage 2, then this stage may optionally be skipped, and/or may optionally and preferably be performed with both previously entered and new parameter(s). Non-limiting examples of such parameters are described above, although of course optionally any such parameters may be used.

In stage 6, the optimization module optimizes the shopping list according to the parameters and their weights; if one or more parameters has an absolute weighting, then such one or more parameters are preferably used to determine the search space first, before other parameters are applied. Optimization is optionally and preferably performed according to price, in order to obtain the best price possible for a basket of goods according to the parameters set by the user.

The user may optionally and preferably switch between brands of products and/or between branded and private label products. The user is also preferably given the option to enlarge the product size (amount and/or unit number and/or volume and/or weight) in order to ultimately save money per unit of product. In addition to comparing baskets by price, the user preferably also receives a comparison by score of the overall product and also preferably of each product in the basket that includes the score of the supplier, score of the products and/or the contribution to society (organic, cooperatives, fair trade compliant, etc.) and/or optionally any other type of score category, such as regarding religious certification.

In stage 7, the optimized shopping list is provided to the user, who may then optionally make one or more changes and/or additions and/or deletions. The user may optionally and preferably switch products between categories (brand/private label, organic/regular and so forth) and/or between suppliers for the product and/or between a supplier for the basket (for example optionally by determining whether to split the basket between two supermarkets and/or between any other plurality of suppliers). The user may also optionally and preferably be directed to consider a substitution, which may for example occur if a particular product is not available through a particular supplier. The user may optionally be requested to consider a different brand and/or a private label and/or to consider whether to switch part or all of the basket between suppliers.

In stage 8, the user accepts the shopping list. Payment and delivery are then preferably handled as previously described.

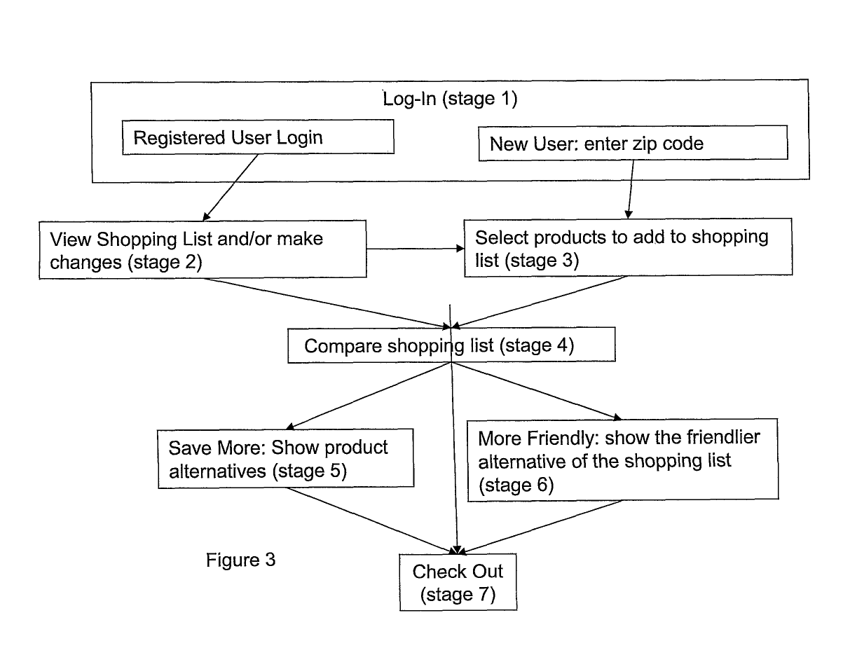

FIG. 3 is a flowchart of an illustrative, exemplary non-limiting method of shopping according to the present invention for operation with the system of FIG. 1. In stage 1, the user, either a new user or a return user, preferably logs into the system or is otherwise identified by the system. Optionally, the user is identified through user authentication means for example optionally including but not limited to software identification using a “cookie” or other stored data and/or software, or via hardware devices such as biometric identification, peripheral device such as a USB key. Preferably, details regarding the user are saved on the shopping server so that the user is identified upon login; optionally previously ordered baskets and/or items are displayed, and/or preferred items and/or preferences are displayed, as shown in stage 2.

If the user is new or is not known to the system, preferably the user is requested to enter location information (such as zip code and/or other geographical and/or address information), after which the user is preferably guided through the log-in process. The user may optionally and preferably enter credit card and/or other payment information, optionally for storage on the system.

In stage 2, the user is optionally provided with a pre-filled shopping list, preferably pre-filled according to one or more preferences of the user and/or according to previous shopping list(s) of the user. If the user's preferences and/or shopping habits are not known, then optionally this stage is skipped.

In stage 3, the user optionally enters one or more products to the shopping list and/or makes one or more changes and/or additions and/or deletions. The user optionally and preferably is provided with a list of products, more preferably by category, from which one or more choices may be made. The list is preferably adjusted according to the previous request(s) for certification and/or preferred suppliers, such that the user preferably only views those products which meet these request(s).

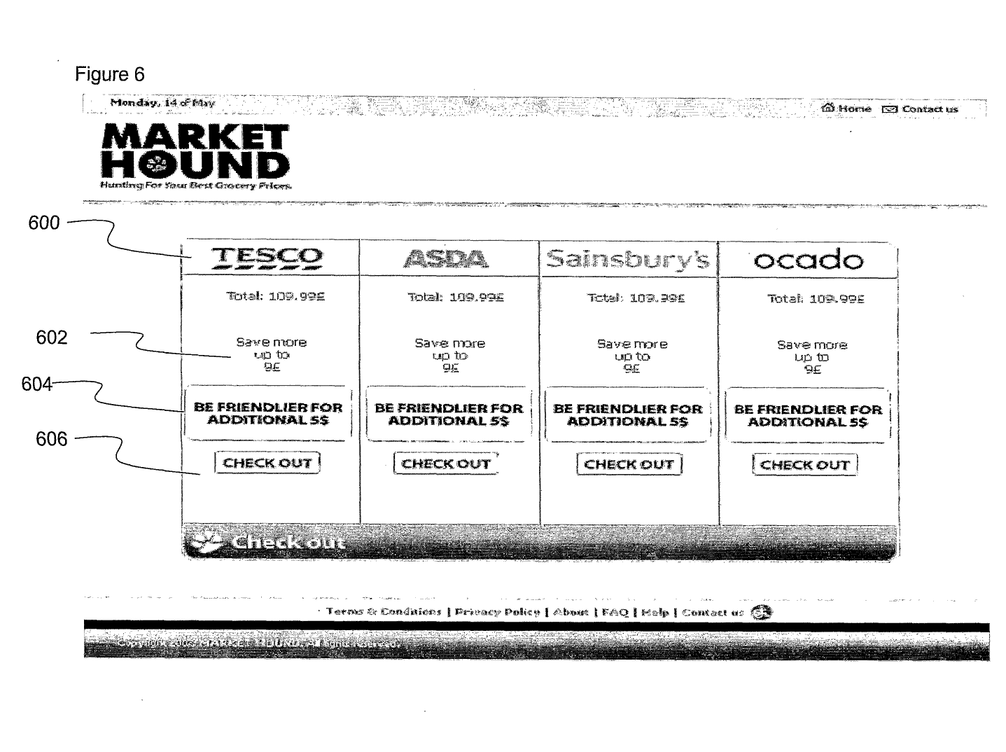

In stage 4, the user is presented with the results of the shopping process where a comparative display is presented to the user allowing the user to choose between the different baskets of choice (see FIG. 6 below).

In stage 5, the user is optionally given the choice to optimize the shopping basket. The optimization may optionally be made according to a savings module allowing the user to consider how much money may be saved by considering alternative supplier for at least one product, packaging, brand names, using multiple suppliers to maximize savings and the like.

Similarly, in stage 6 the optimization process may optionally and preferably suggest the friendlier options available to the user by presenting to the user product alternative based on optimization of comparable friendlier products from either the same supplier or a different supplier. For example the optimization module of the present invention would optionally offer the user alternative products to those that are on the shopping list, suggesting that a detergent purchased with a first supplier be changed with an animal friendly detergent from a second supplier as an alternative to the chosen detergent, while optionally at the same time suggesting the exchanging produce selected from the first supplier for organic produce from a third supplier.

In stage 7, the user accepts the shopping list. Payment and delivery are then preferably handled as previously described.

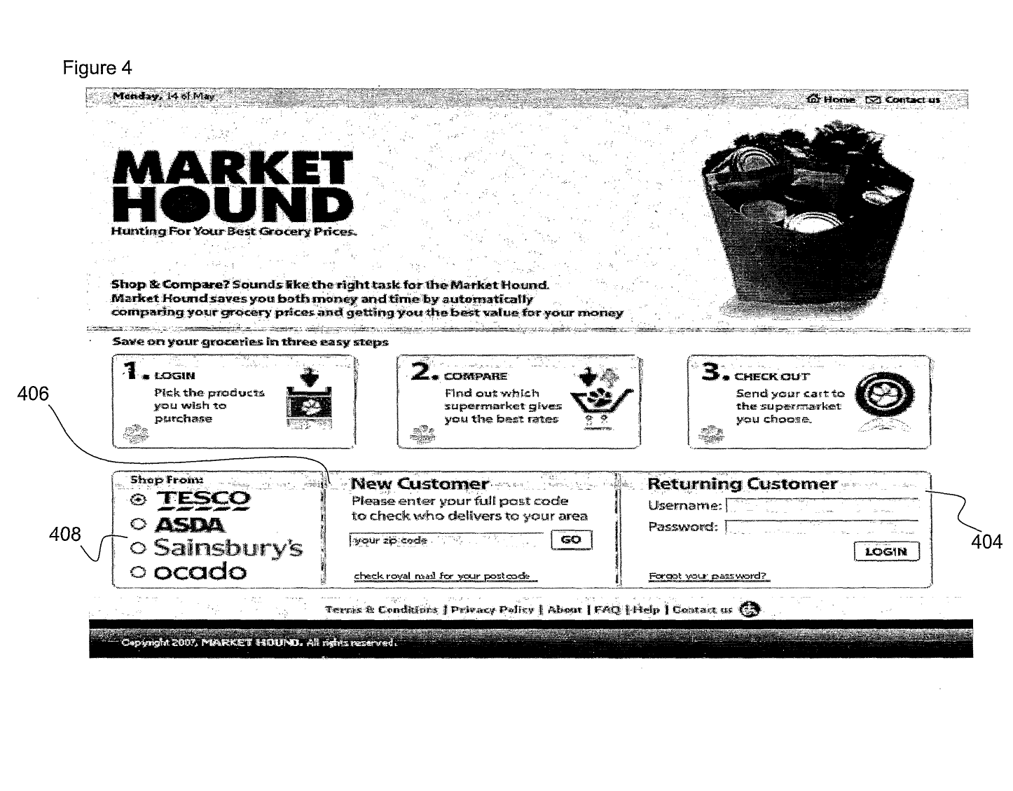

FIG. 4 is a non limiting illustration of a graphical user interface (GUI) of the login process according to the present invention as described in stage 1 of FIGS. 2 and 3. Preferably a registered user would access the system and method of the present invention using interface 404 while a new user would log-in using text box 404 optionally providing the postal code for localization purposes. Optionally a first supplier is selected from supplier list 408.

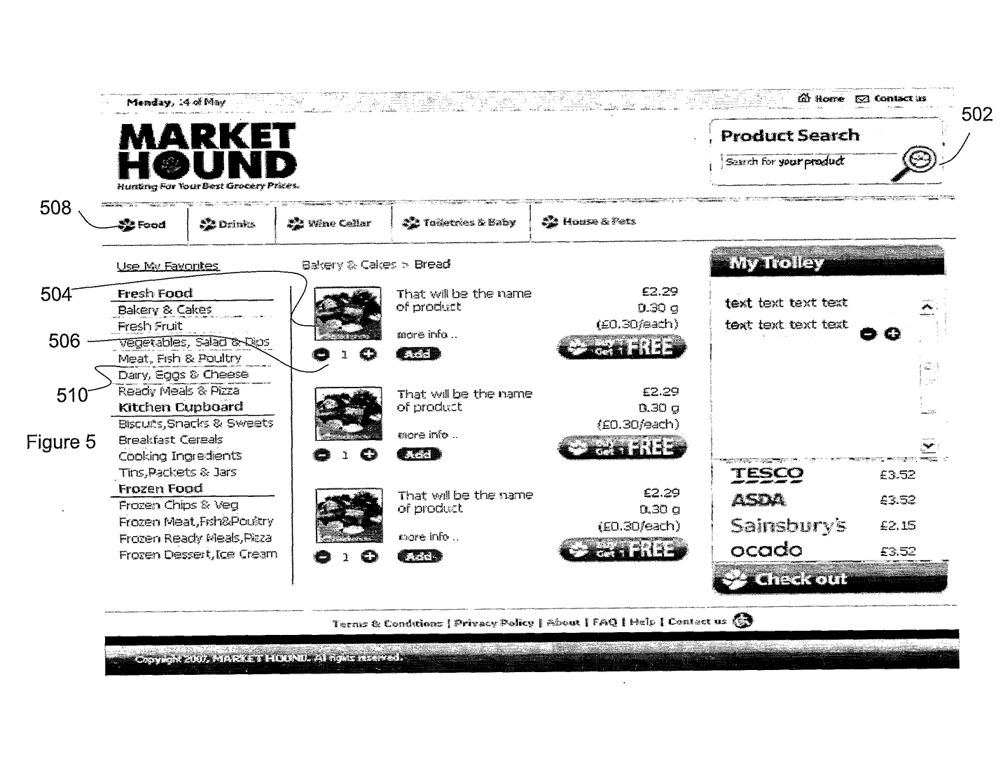

FIG. 5 is a non limiting illustration of a GUI showing the product search and product selection process according to the present invention as described in stage 2 of FIG. 3 above. Optionally, the user enters the search string in text box 502. The results are displayed in box 504 while the amount of the product may be changed by using the increment buttons 506. The various product categories are presented in tabs 508 while the products in the respective category are presented in display box 510.

Optionally and preferably, if the user interface is being displayed to the user through a portable computer, such as a PDA or a cellular telephone, or any other device having a small screen, then the results are preferably displayed such that the user does not need to scroll between pages.

FIG. 6 is a non limiting illustration of a GUI showing the basket comparison result 600 depicting the various shopping list alternatives. Also displayed are the exemplary optimization options available optionally optimization by saving money 602 or optimization according to friendlier, products 604. Lastly, the check out 606 option is available allowing the user to choose a particular basket.

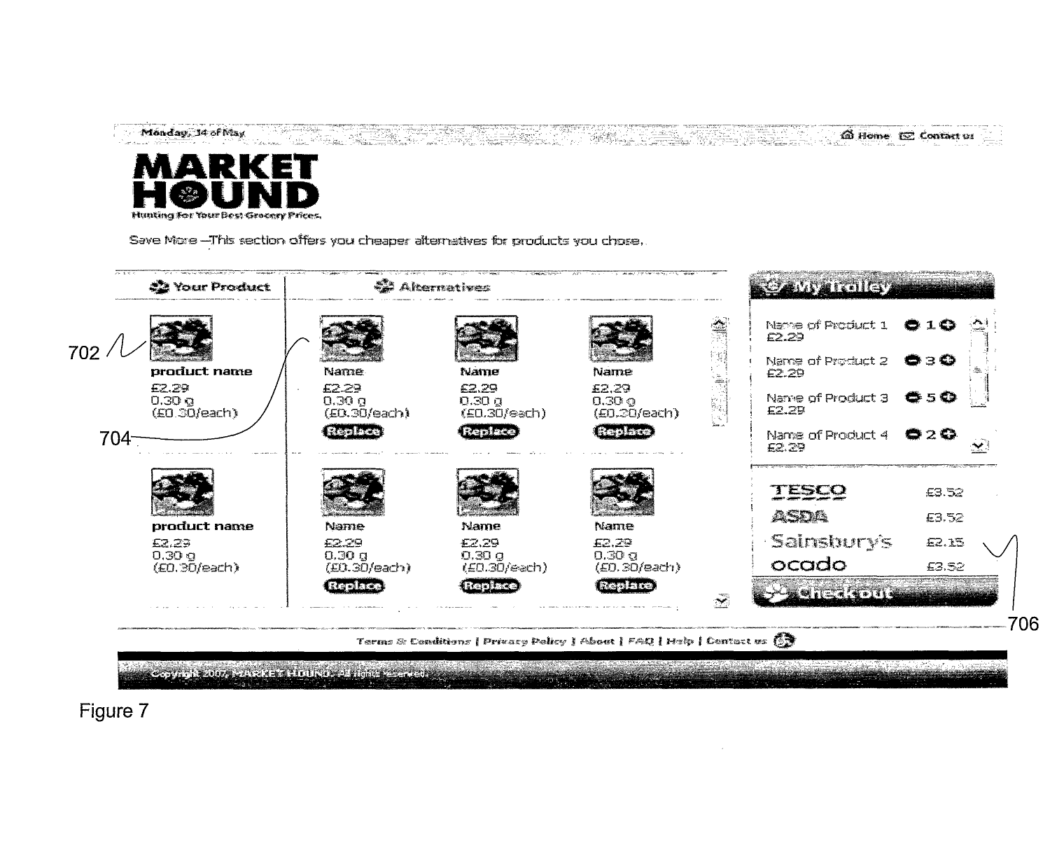

FIG. 7 is a non limiting illustration of a GUI showing the money saving optimization process 602 of FIG. 6 above. Both current product 702 and alternative products 704 are depicted; furthermore, the savings 706 is optionally displayed.

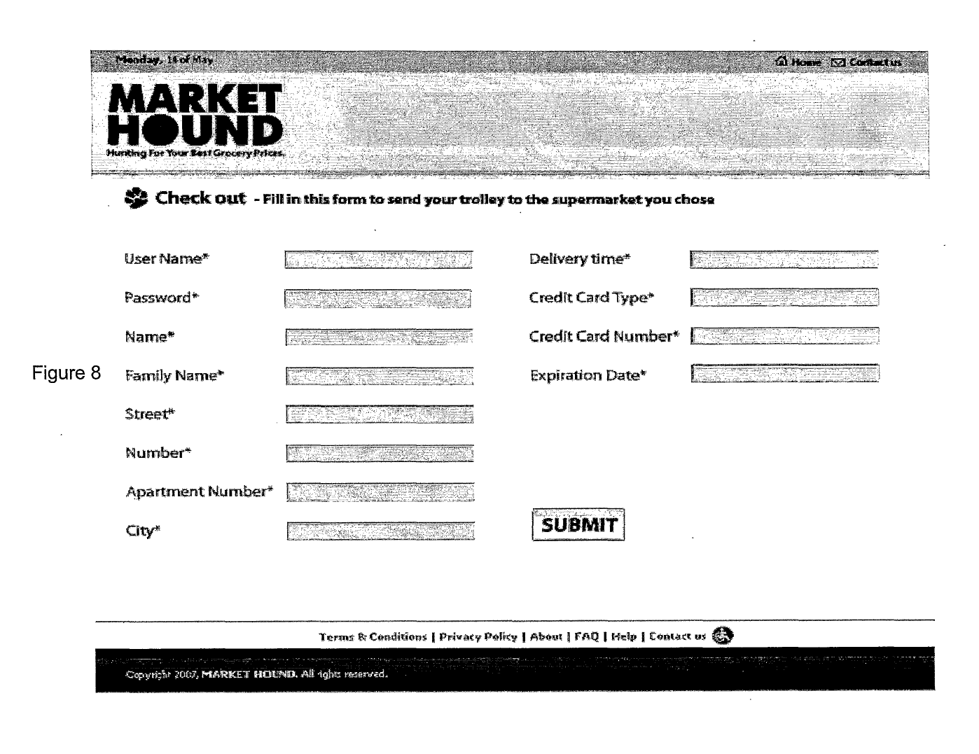

FIG. 8 is a non limiting illustration of a GUI depicting the checkout process 606 of FIG. 6 above. Information depicting the delivery details are optionally requested, more preferably the requested details may optionally be stored for future use or displayed based on the user's previous use.

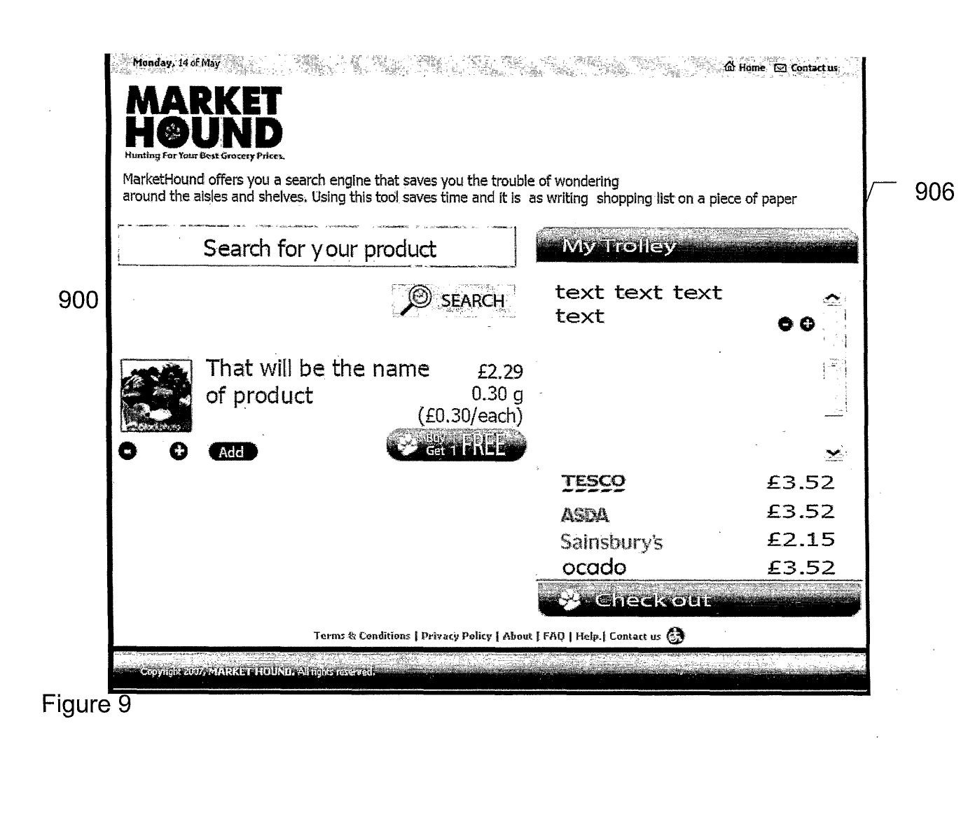

FIG. 9 is a non limiting illustration of a GUI depicting the search process of FIG. 3 above. As shown, the user is preferably provided with a text box 900 for entering search details and is requested to “click on” or otherwise indicate a search initiation button 902, which could optionally be any type of GUI gadget. Product information 904 about any located product(s) is then preferably provided, optionally including but not limited to one or more of the name of the product, the quantity, the price per unit, the total price and any offers or special prices (such as “buy one, get one free” as shown).

A “running total” of any product(s) indicated for purchase is shown in a shopping trolley 906, which may optionally include a comparison for a plurality of stores and/or other sources for purchasing the products in terms of total cost and/or savings obtained from each such store and/or source.

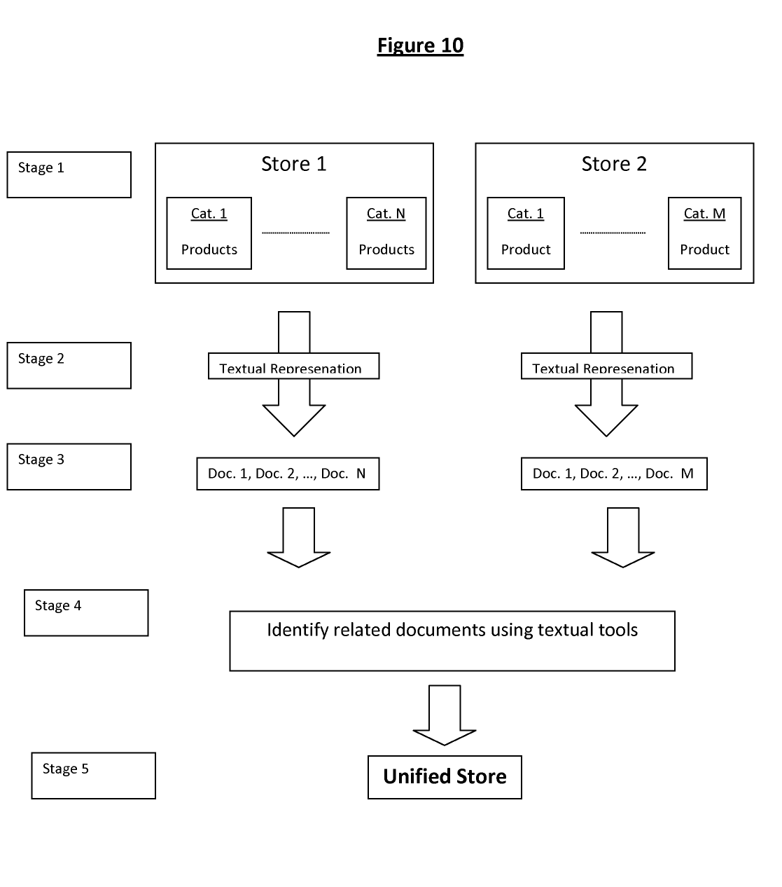

FIG. 10 is an illustrative, exemplary non-limiting method for combining information from a plurality of stores into a unified “store”. The unified “store” may optionally be presented as described above, for example through the above described illustrative GUI; alternatively or additionally, the combined data may optionally be used for any other type of interaction with the end user (consumer).

As shown, in stage 1, data is gathered for a plurality of products in a plurality of different categories from a plurality of stores and/or other providers or suppliers as described herein. It is not necessary for the stores to predetermine such categories for the products; instead, the product information is optionally and preferably provided in a textual representation that relates to the product itself. Any category information provided may optionally be determined according to the categories of each store, without any necessary correspondence between the categories of different stores.

In stage 2, the information provided is converted to a simple textual representation; all images, sounds and other types of data are preferably removed, such that only the text remains. This stage may optionally necessitate OCR (optical character recognition) if the information provided is in an image or other non-textual format.

In stage 3, the text information, which may for example optionally (but not necessarily) be provided in a plurality of documents, is preferably converted from a collection of a plurality of words (or “bag of words”) to a vector of words. The vector of words may optionally be a “normalized word vector”, which represents the content of a document (or of the provided text, regardless of whether it is organized into a document). The dimensions of the space are derived from the number of core concepts in a thesaurus or other listing of core concepts. Optionally and preferably, such a listing of core concepts is specifically derived for the store(s) and/or categories or types of stores. It may optionally be simplified by reducing the number of core concepts. Alternatively, the thesaurus may optionally be any regular thesaurus, in which case the number of core concepts is typically 800-1000 in a modern electronic thesaurus.

The coordinates of each NWV can be computed by counting the number of times each of the listed concepts occurs in the document under consideration. In order to determine the concept counts required to build this vector representation, each word in the document is preferably “normalized”, or in other words reduced to a thesaurus (or other list) root word appropriate to the concept. These concept counts are then used for the vector representation. Optionally, before this process of counting concepts, words that are considered to be too common or otherwise not useful may optionally be removed and/or alternatively or additionally may be discounted during the process of determining the normalized vector.

In stage 4, related documents (or other units of information) are preferably identified by comparing such word vectors, which are preferably normalized word vectors as described above. Such comparison may optionally be performed according to any suitable method as is known in the art, for example by comparing vectors according to a distance function and/or a correlation function. The extent to which two or more documents (or other units of information) are related is optionally and preferably determined according to a confidence interval or other parameter(s), which may optionally be adjusted in order for the stringency of the comparison to be increased or decreased.

A non-limiting example of such a method is the use of the tf-idf (term frequency-inverse document frequency) weight, which is a weight often used in information retrieval and text mining. This weight is a statistical measure used to evaluate how important a word is to a document in a collection of a plurality of such documents. The importance increases proportionally to the number of times a word appears in the document but is reduced by the overall frequency of the word in the total collection. Other non-limiting examples include the use of k-means clustering (as described for example in US Patent Application No. 20080215314, hereby incorporated by reference as if fully set forth herein).

The above process may optionally be performed with regard to semantics, as described for example in US Patent Application No. 20080221878, hereby incorporated by reference as if fully set forth herein; or without any regard to semantics, concentrating only on the word (or term) count frequency as described above.

In stage 5, the related documents are preferably combined to form a set of information for the united store. For example, optionally the information from the related documents is first combined by category. Next, information regarding products from each category is optionally combined. Alternatively, information regarding all products is optionally first combined, followed by sorting products into previously determined categories. In any case, the categories for this stage are preferably determined for the on-line store user interface as previously described, for example optionally and preferably to construct the optimized shopping list.

Furthermore, information from the suppliers is also optionally and preferably used to construct the optimized shopping list, for example (and without limitation) to determine whether a particular product from a particular supplier satisfies a user preference and/or whether the price is suitable and/or to determine the relative weighting of a particular product from a particular supplier with regard to optimizing the shopping list. Such optimization is optionally and preferably performed by the optimization module of FIG. 1 and/or according to any process as described herein.

While the invention has been described with respect to a limited number of embodiments, it will be appreciated that many variations, modifications and other applications of the invention may be made.

What is claimed is:

1. A method for interactively constructing a shopping list for a user, the method being performed by a computer, the method comprising:
determining a plurality of weighted parameters for preferences of the user, each parameter being weighted according to a relative preference of the user;
automatically selecting shopping items from a plurality of providers according to said weighted parameters;
automatically constructing the shopping list according to selected shopping items for the user; and
outputting the shopping list to one or more of a computer display, a provider interface or a printer.

2. The method of claim 1, wherein at least one preference is a negative preference, such that said at least one parameter has a negative weight.

3. The method of claim 1, wherein at least one preference is an absolute preference which must be fulfilled.

4. The method of claim 3 wherein said weighted parameters further comprise parameters relating to at least one of cost, friendlier products, brand name products, an identity of a supplier of a product, a certified product and products corresponding to at least one dietary restriction.

5. The method of claim 4, wherein said friendlier products include at least one of an organic product, an environmentally friendly product and an ethical product.

6. The method of claim 5, wherein cost includes cost of a product.

7. The method of claim 6, wherein cost includes cost of all of said shopping items.

8. The method of claim 7, wherein cost includes cost of delivery of one or more of said shopping items, or all of said shopping items.

9. The method of claim 8, wherein at least one provider is a “bricks and mortar” store.

10. The method of claim 9, wherein at least one provider is a virtual store.

11. The method of claim 10, wherein said virtual store comprises a farmers' cooperative.

12. The method of claim 11, further comprising:
observing a plurality of purchases by the user;
determining at least one pattern of shopping by the user; and
providing a suggested shopping list according to said at least one pattern of shopping by the user.

13. The method of claim 12, further comprising:
Searching for at least one product according to a request by the user according to a search string and/or a category through a user interface; and
Adding a product located through said searching to the shopping list for the user.

14. A system for interactively constructing a shopping list for a user, comprising:
A user computer for entering at least one preference of the user;
A server for receiving said at least one preference and for:
determining a plurality of weighted parameters for preferences of the user, each parameter being weighted according to a relative preference of the user;
automatically selecting shopping items from a plurality of providers according to said weighted parameters; and
constructing the shopping list according to selected shopping items for the user; and
a network for connecting said user computer and said server.

15. A method for unifying information from a plurality of providers for constructing a shopping list for a user, the method being performed by a computer, the method comprising:
Receiving a plurality of provider documents from a plurality of provider computers through a provider interface, said provider documents relating to a plurality of provider products in a plurality of provider categories;
Analyzing said plurality of provider documents to determine at least a plurality of word vectors;
Determining similarity of said provider documents by comparing said word vectors;
Combining said provider documents according to said similarity;
Selecting shopping items from said plurality of providers according to the shopping list and said combined provider documents; and
outputting the shopping list to one or more of a computer display, said provider interface or a printer.

16. The method of claim 15, further comprising: displaying the shopping list to said user on a user computer.

17. The method of claim 16, wherein said similarity is determined according to a correlation function between said word vectors.

18. The method of claim 17, further comprising:
observing a plurality of purchases by the user through the user computer;
determining at least one pattern of shopping by the user; and
providing a suggested shopping list for display on the user computer according to said at least one pattern of shopping by the user.
